(19) United States
(12) Patent Application Publication
(10) Pub. No.: US 2003/0021593 A1
(43) Pub. Date: Jan. 30, 2003

(54) Method of controlling the operations mode of an optical disc player between a video playback mode and a user agent mode

(76) Inventors: Masato Otsuka, Torrance, CA (US); Ramaswamy Devarajan, Long Beach, CA (US); Sanjay Kulkarni, Torrance, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/906,982

(22) Filed: Jul. 17, 2001

Related U.S. Application Data
(60) Provisional application No. 60/288,372, filed on May 3, 2001.
(60) Provisional application No. 60/293,435, filed on May 24, 2001.

(51) Int. Cl. H04N 7/04; H04N 5/781

(52) U.S. Cl. 386/126; 386/105

(57) ABSTRACT

A method of controlling the operations mode of an optical disc player between a user agent mode and a video playback mode. The method comprises reading a program stored on a local optical disc that may includes a function that specifies either the user agent mode or the video playback mode as the operations mode for the optical disc player. Once the function is read, the operations mode of the optical disc player is changed to the specified mode. In one embodiment, the function changes the operations mode while also disabling the user control interface to prevent a user from changing the operations mode. In another embodiment, the function changes the operations mode of the optical disc player without disabling the user control interface, thereby allowing a user to change the operations mode of the optical disc player.

### CROSS REFERENCE TO RELATED APPLICATIONS

This patent application claims the benefit of the respective filing dates of Provisional Patent Application, Serial No. 60/288,372, filed on May 3, 2001, entitled “Seamless Context Switching Between Video mode and User Agent Mode in an Optical Disc Player”, and Provisional Patent Application, Serial No. 60/293,435, filed on May 24, 2001, entitled “Method of Controlling the Operations Mode of an Optical Disc Player Between a Video Playback Mode and a User Agent Mode”, both of which are incorporated herein by reference.

### FIELD OF THE INVENTION

This invention relates generally to optical disc players, such as digital versatile disc (DVD) players and other formats, that have network (e.g. the Internet) access capability. In particular, the invention relates to a method of controlling and switching the operations mode of an optical disc player between a video playback mode and a user agent mode.

### SUMMARY OF THE INVENTION

The invention allows optical disc players to seamlessly operate in two modes: in a video playback mode and a user agent mode. In video playback mode, the optical disc player functions to access and display video content stored on the local optical disc, such as would a standard DVD player. In video playback mode, the video menu is activated to allow a user to control the playback of the video content. In user agent mode, the optical disc player is configured to run a user agent program stored in the local optical disc to allow a user to browse websites (e.g. access HTML documents) available on a network and in the local optical disc, and perform various functions associated with the websites. Also in the user agent mode, the video content stored on the local optical disc may be shown within the user agent window. In user agent mode, the user agent menu is activated to allow a user to control the playback of the video content.

The invention allows content developers to develop programs that provide interaction between the video playback function and the user agent function of an optical disc player. These programs generally reside on the local optical disc. When the optical disc is inserted into the optical disc player, the optical disc player can read and execute an interaction program on the local optical disc to perform an operation that interacts the video playback function with the user agent function in a specified manner dictated by the program. In many instances, a content developer may want to develop a program that can switch the operations mode of the optical disc player between the video playback mode and the user agent mode in a particular manner, and/or restrict the operation to one particular mode. Such as, for example, the program may cause the optical disc player to operate in video playback mode in order to display a particular video segment while restricting the user from changing the mode, then after the video segment has ended, to switch to the user agent program for accessing a particular website or performing another function, while allowing the user to switch modes at that point.

As discussed below, the invention may be embodied as a method of controlling the operations mode of an optical disc player between a user agent mode and a video playback mode. Also, the invention may be embodied as an optical disc that can be read to control the operations mode of an optical disc player between a user agent mode and a video playback mode. Additionally, the invention may be embodied as a computer readable medium (e.g. a volatile or non-volatile memory) that stores a program interpreter that recognizes and causes the execution of a function stored in a local optical disc of an optical disc player that changes the operations mode of an optical disc player between a user agent mode and a video playback mode. Furthermore, the invention may be embodied as an optical disc player that can read an interactive program stored on a local optical disc that controls the operations mode of the optical disc player between a user agent mode and a video playback mode.

More specifically, an aspect of the invention relates to a method of controlling the operations mode of an optical disc player between a user agent mode and a video playback mode. The method comprises reading an interactive program stored on a local optical disc, wherein the interactive program includes a function that specifies either the user agent mode or the video playback mode as the operations mode for the optical disc player. Once the function is read, the operations mode of the optical disc is changed to the specified mode. In one embodiment, the function is a bool ForceMode (int mode) where the changing of the operations mode also results in the disabling of the user control interface to prevent a user from changing the operations mode of the optical disc player. In another embodiment, the function is a bool SwitchMode (int mode) which changes the operations mode of the optical disc player without disabling the user control interface, thereby allowing a user to change the operations mode of the optical disc player. A further function is a bool AllowModeSwitch( ) function which enables the user control interface thereby allowing a user to change the operations mode of the optical disc player.

Another aspect of the invention relates to an optical disc that can be read to control the operations mode of an optical disc player between a user agent mode and a video playback mode. The optical disc includes an interactive program having a function that causes the optical disc player to change the operations mode from the user agent mode to the video playback mode or vice-versa. In one embodiment, the function is a bool ForceMode (int mode) where the changing of the operations mode also results in the disabling of the user control interface to prevent a user from changing the operations mode of the optical disc player. In another embodiment, the function is a bool SwitchMode (int mode) which changes the operations mode of the optical disc player without disabling the user control interface, thereby allowing a user to change the operations mode of the optical disc player. A further function is a bool AllowModeSwitch( ) function which enables the user control interface thereby allowing a user to change the operations mode of the optical disc player.

Yet another aspect of the invention relates to a computer readable medium that stores a program interpreter that recognizes and causes the execution of a function stored in a local optical disc of an optical disc player, wherein the function causes the changing of an operations mode of an optical disc player from a user agent mode to a video playback mode or vice-versa. In one embodiment, the function is a bool ForceMode (int mode) where the changing of the operations mode also results in the disabling of the user control interface to prevent a user from changing the operations mode of the optical disc player. In another embodiment, the function is a bool SwitchMode (int mode) function which changes the operations mode of the optical disc player without disabling the user control interface, thereby allowing a user to change the operations mode of the optical disc player. The program interpreter also recognizes and causes the execution of another function bool AllowModeSwitch( ) function which enables the user control interface, thereby allowing a user to change the operations mode of the optical disc player.

Still another aspect of the invention relates to an optical disc player comprising an optical disc reading device to read an interactive program stored on a local optical disc, a video/audio interface to interface with a displaying device for displaying a user agent menu and/or a video playback menu, and a processor to execute a function of the interactive program which changes the operations mode of the optical disc player from a user agent mode where the user agent menu is activated for interaction by a user to a video playback mode where the video playback menu is activated for interaction by the user, or vice versa. In one embodiment, the function is a bool ForceMode (int mode) where the changing of the operations mode also results in the disabling of the user control interface to prevent a user from changing the operations mode of the optical disc player. In another embodiment, the function is the bool SwitchMode (int mode) which changes the operations mode of the optical disc player without disabling the user control interface, thereby allowing a user to change the operations mode of the optical disc player. Also, the optical disc player can also recognize and cause the execution of another function bool AllowModeSwitch( ) which enables the user control interface thereby allowing a user to change the operations mode of the optical disc player.

Other aspects, features, and techniques will become apparent to those skilled in the relevant art in view of the following detailed description of the invention.

### BRIEF DESCRIPTION OF THE DRAWINGS

FIG. 1 illustrates a block diagram of an exemplary optical disc player having network access capability in accordance with the invention;

FIG. 2A illustrates a displaying device displaying a frame of a video content in video playback mode;

FIG. 2B illustrates a displaying device displaying a website document in user agent mode;

FIG. 3 illustrates a flow diagram of exemplary operations of the optical disc player as a result of the execution of the various functions in accordance with the invention; and

FIG. 4 illustrates a flow diagram of the operations of the optical disc player when the user control interface is enabled and the user changes the mode.

### DETAILED DESCRIPTION OF THE INVENTION

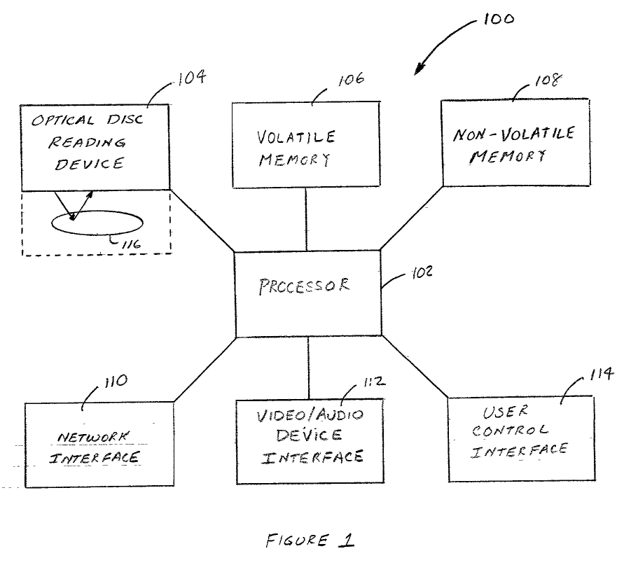

FIG. 1 illustrates a block diagram of an exemplary optical disc player 100 having network access capability in accordance with the invention. The optical disc player 100 comprises an optical disc reading device 104, a volatile memory 106 (e.g. random access memory), a non-volatile memory 108 (e.g. a magnetic hard disk, flash read only memory (ROM), an electrically erasable programmable read only memory (EEPROM), a network interface 110 (e.g. an interface to the Internet), a video/audio device interface 112, and a user control interface 114. All of the elements are data coupled to a centralized processor 102 as represented by the lines drawn respectively from these elements to the processor 102. The hardware configuration of the optical disc player 100 is not critical to the invention, and can encompass many different hardware configuration types. For instance, the optical disc player 100 can be implemented as a dedicated optical disc player or a personal computer.

The optical disc player 100 can operate in at least two modes: a video playback mode and a user agent mode. In video playback mode, the optical disc player 100 functions to access and display video content stored on the local optical disc 116, such as would a standard DVD player. In video playback mode, the video menu displayed on displaying device (e.g. television, computer monitor) is used to control the playback of the video content. In user agent mode, the optical disc player is configured to run a user agent program (e.g. a browser) to allow a user to access website documents on a network or stored in the local optical disc 116, and perform various functions associated with the website document. In the user agent mode, the video content stored on the local optical disc 116 may be shown in a framed window within the user agent window. In user agent mode, the user agent menu is used to control the playback of the video content.

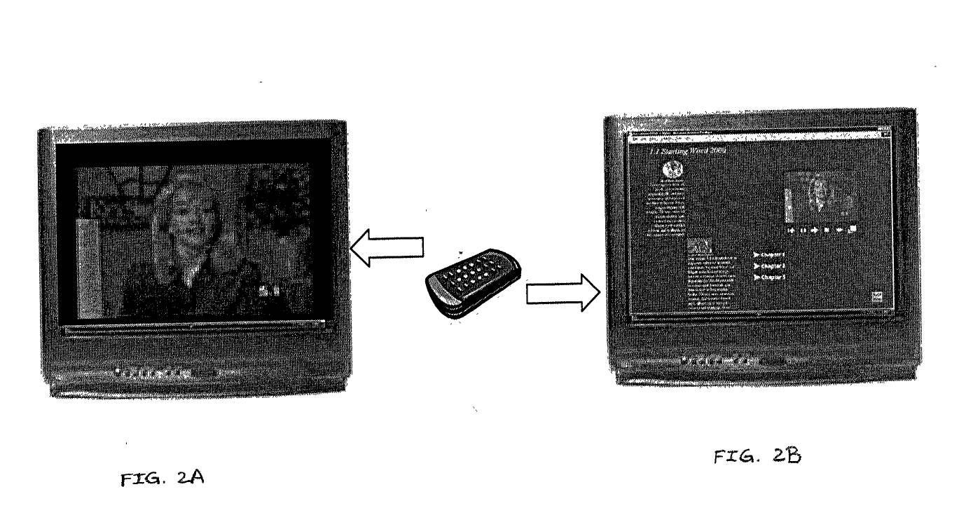

FIG. 2A illustrates a displaying device 200 coupled to the video/audio device interface 112 displaying a frame of a video content in video playback mode. In this mode, the displaying device 200 displays full screen video as would a standard DVD player. Thus, in video playback mode, the optical disc player 100 of the invention operates as a standard DVD player. In this case, the video playback menu controls the playback of the video content stored on the local optical disc 116. This is to allow compatibility with standard DVD players.

FIG. 2B illustrates a displaying device 250 coupled to the video/audio device interface 112 displaying a website document (e.g. an HTML document) in user agent mode. As customary, the website document may include information, pictures, and links to other website documents. In addition, the website document may include a frame window for displaying the video content stored on the local optical disc 116. In this case, the HTML menu controls the playback of the video content stored on the local optical disc 116.

An aspect of the invention relates to a method of controlling the operations mode of the optical disc player 100 between the video playback mode and the user agent mode. The method allows content developers to develop programs stored on the local optical disc 116 that interacts the video playback mode with the user agent mode. For instance, a content developer may want to develop a program that can switch the operations mode of the optical disc player 100 between the video playback mode and the user agent mode in a particular manner, and/or restrict the operation to one particular mode. Such as, for example, the program may cause the optical disc player to operate in video playback mode in order to display a particular video segment while restricting the user from changing the mode, then after the video segment has ended, to switch to the user agent program for accessing a particular website or performing another function, while allowing the user to switch modes at that point.

In order to accomplish this, the optical disc player 100 incorporates a program interpreter that recognizes certain functions stored in a program on the local optical disc 116 that controls the operations mode of the optical disc player 100. These functions include the bool ForceMode (int mode), bool SwitchMode (int mode), and bool AllowModeSwitch( ). The bool ForceMode (int mode) function causes the optical disc player 100 to operate in the specified “mode” as well as disables the user control interface 114 to prevent a user from changing the operations mode. The bool SwitchMode (int mode) function causes the optical disc player 100 to operate in the specified “mode” but does not disable the user control interface 114. The bool AllowModeSwitch( ) function causes the optical disc player 100 to enable the user control interface to allow a user to change between the video playback mode and the user agent mode. The following are examples of how these functions can be defined:

Function: bool ForceMode (int mode)

Description: Forces a mode switch to the playback mode specified by “mode”. Also disables the UOP button “MODE”. User mode switch is prohibited after making the “ForceMode” command.

Parameters: mode, an integer value,

0. Reserved

1. User_Agent_Mode

2. Video_Playback_Mode

Return Value: Boolean, “True” if function succeeds, “False” otherwise.

Function: bool SwitchMode (mode)

Description: Switches mode to the playback mode specified by “mode”. This function does not disable the UOP button “MODE”.

Parameters: mode, an integer value,

0. Reserved

1. User_Agent_Mode

2. Video_Playback_Mode

Return Value: Boolean, “True” if function succeeds, “False” otherwise.

Function: bool AllowModeSwitch( )

Description: Enables mode switching. Call this function if you make “ForceMode” command to enable player for mode switching. Also enables UOP button “MODE”.

Parameters: None

Return Value: Boolean, “True” if function succeeds, “False” otherwise.

Content developers can incorporate one or more of these functions in a program stored on the local optical disc 116 to interact video playback mode with user agent mode in a desired fashion. The following discussion details how the optical disc player 100 reads and executes such a program.

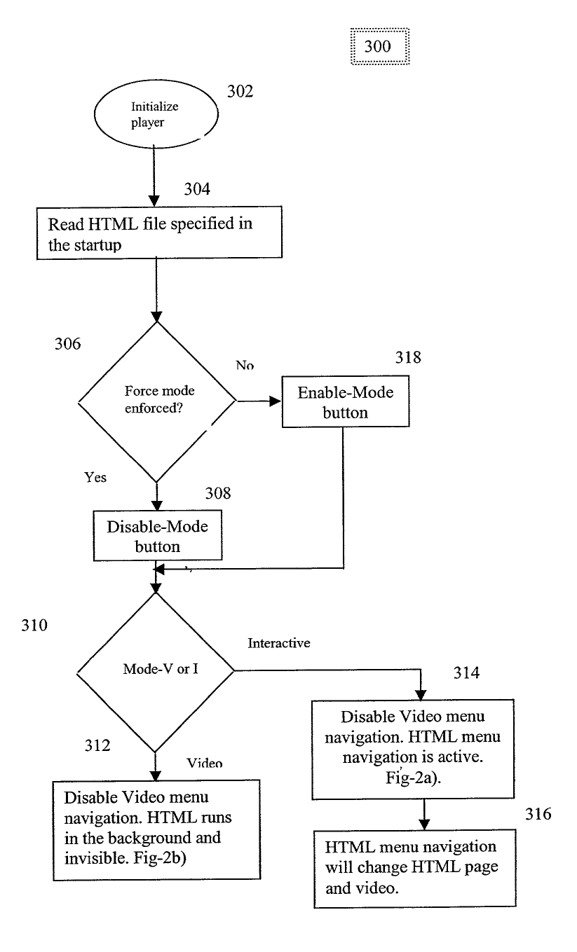

FIG. 3 illustrates a flow diagram of the operations 300 of the optical disc player 100 as a result of the execution of the various functions described above. In step 302, the optical disc player 100 is initialized by turning it on. Upon start-up, the processor 102 loads an initial operating system program stored in the non-volatile memory 108. The processor 102 under the control of the operating system detects when there is a local optical disc 116 present in the optical disc reading device 104. When such is detected, in step 304 the processor 102 under the control of the operating system checks whether the local optical disc 116 has a certain startup file (e.g. DVDP.INF) that identifies a start-up interactive program (e.g. an HTML file). If the startup file is present, the processor 102 under the control of the operating system loads a program interpreter from non-volatile memory 108 to read and execute the start-up interactive program. The program interpreter recognizes the bool ForceMode (int mode), bool SwitchMode (int mode), and bool AllowModeSwitch( ) functions that may be present in the start-up interactive program.

In step 306, if the program interpreter reads the bool ForceMode (int mode) function from the start-up interactive program on the local optical disc 116, the processor 102 under the control of the program interpreter disables the user control interface 114 to prevent a user from changing the operations mode of the optical disc player 100. If in step 306 the program interpreter reads the bool SwitchMode (int mode), in step 318 the processor 102 under the control of the program interpreter enables the user control interface 114 to allow a user to change the operations mode of the optical disc player 100.

Then, in step 310, the processor 102 under the control of the program interpreter determines the operations mode of the optical disc player 100 specified in the mode variable. If the specified mode is video mode, in step 312 the processor 102 under the control of the program interpreter activates the video playback program which displays the appropriate video on the displaying device. If the specified mode is the user agent mode, in step 314 the processor 102 under the control of the program interpreter activates the user agent program which displays the appropriate HTML menu, and disables the video menu. In step 316, a user can use the HTML menu to perform web related function, such as retrieving a web document from a network coupled to the network interface 110 or a web document stored on the local optical disc 116.

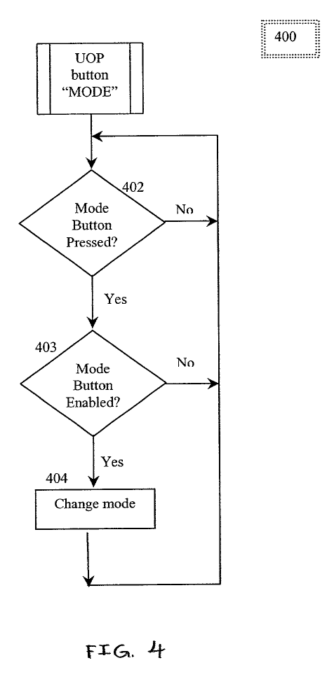

FIG. 4 illustrates a flow diagram of the operations 400 of the optical disc player 100 when the user control interface 114 is activated by a user. In step 402, the processor 102 determines whether the user mode switch button has been pressed. If the user switch mode button has not been pressed, the processor 102 merely loops back to step 402. In step 403, the processor 102 determines whether the mode button is enabled. If the mode button is enabled, the processor 402 changes the operations mode of the optical disc player 100 and returns to step 402 again. If the mode button is not enabled, the processor 102 loops back to step 402.

The following describes various data structures for storing data related to the operations of the optical disc player 100 in accordance with the invention. The first data structure listed below is the player_mode_info_struct data structure:

typedef struct player_mode_info_struct {

PLAYER_MODE mode;

DISPLAY_MODE display_mode;

SCREEN_STATE screen_state;

USER_PREF user_pref;

WEB_PAGE_INFO web_page_info;

} PLAYER_MODE_INFO_STRUCT;

The PLAYER_MODE mode variable specifies the current operations mode of the optical disc player 100. The following is an exemplary definition of the PLAYER_MODE mode variable:

| | |
|---|---|
| typedef enum player_mode { | |
| PLAYER_User_Agent_MODE = 0×01, | // User-agent-mode |
| PLAYER_Video_MODE = 0×02 | // Video-playback-mode |
| } PLAYER_MODE; | |

Thus, if the PLAYER_MODE mode value is PLAYER_User_Agent_MODE=0×01, then the optical disc player's current operations mode is the user agent mode. If the PLAYER_MODE mode value is PLAYER_Video_Mode=0×02, then the optical disc player's current operations mode is the video playback mode.

The DISPLAY_MODE display_mode variable specifies the display mode of the optical disc player 100. The following is an exemplary definition of the DISPLAY_MODE display_mode variable:

| | |
|---|---|
| typedef enum display_mode { | |
| DISPLAY_WEB_FULLSCREEN, | // User-agent-mode: Browser full screen |
| DISPLAY_WEB_IN_WINDOW, | // User-agent-mode: Browser in small window over |
| DVD | |
| DISPLAY_VID_IN_WINDOW, | // user-agent-mode: Video in small window over |
| browser | |
| DISPLAY_VID_FULLSCREEN, | // Video-mode: Fullscreen DVD Playback |
| DISPLAY_PIC_IN_PIC | // Picture-in-picture mode |
| } DISPLAY_MODE; | |

Thus, if the DISPLAY_MODE display mode value is DISPLAY_WEB_FULLSCREEN, then the displaying device coupled to the video/audio device interface 112 displays the full screen user agent menu. If the DISPLAY_MODE display_mode value is DISPLAY_WEB_IN_WINDOW, then the displaying device coupled to the video/audio device interface 112 displays the user agent menu in a window over the video playback menu. If the DISPLAY_MODE display_mode value is DISPLAY VID_IN WINDOW, then the displaying device coupled to the video/audio device interface 112 displays the video playback menu over the user agent menu. If the DISPLAY_MODE display mode value is DISPLAY_VID_FULLSCREEN, then the displaying device coupled to the video/audio device interface 112 displays the full screen video playback menu. If the DISPLAY_MODE display_mode value is DISPLAY_PIC_IN_PIC, then the displaying device coupled to the video/audio device interface 112 displays video playback mode and/or user agent mode in picture-in-picture format.

The SCREEN STATE screen state data structure includes several variables for defining the screen parameters for user agent mode and video playback mode. The following is an exemplary definition of the SCREEN_STATE screen state variable:

| | |
|---|---|
| typedef struct screen_state { | |
| int VID_WINDOW_WIDTH; | |
| int VID_WINDOW_HEIGHT; | |
| int WEB_WINDOW_WIDTH; | |
| int WEB_WINDOW_HEIGHT; | |
| int VID_WINDOW_X; | // x-coordinate of window from top of the screen |
| int VID_WINDOW_Y; | // y-coordinate of window from top of the screen |
| int WEB_WINDOW_X; | |
| int WEB_WINDOW_Y; | |
| } SCREEN_STATE | |

The int VID_WINDOW_WIDTH and VID_WINDOW_HEIGHT variables respectively define the width and height of the video playback screen, the int WEB_WINDOW_HEIGHT and WEB_WINDOW_HEIGHT variables respectively define the width and height of the user agent screen, the VID_WINDOW_X and VID_WINDOW_Y variables respectively define the x-and y- coordinates of the top left of the video playback screen, and the WEB_WINDOW_X and WEB_WINDOW_Y variables respectively define the x-and y- coordinates of the top left of the user agent screen.

The USER_PREF user_pref variable is a user defined variable which allows content developers to style the appearance of the user agent screen and the video playback screen. The following is an exemplary definition of the USER_PREF user_pref variable:

typedef struct user_preference{
// User defined
} USER_PREFERENCE;

The WEB_PAGE_INFO web page info variable defines the path (e.g. a URL path) of the current web document retrieved by the user agent program. The following is an exemplary definition of the WEB_PAGE_INFO web_page variable:

| | |
|---|---|
| typedef struct web_page_info { | |
| string web_page; | // web page name including its path |
| } WEB_PAGE_INFO; | |

where the string web_page variable define the path to the current web document.

The following is an example of a start-up interactive program that a content developer can create to perform a desired interaction between user agent mode and video playback mode. This program causes a force mode to video playback mode, starts playing chapter 1 of a video clip, and after the playback of chapter 1 is complete, switches to user agent mode to launch Wmain.htm. Then after selection of a menu item in Wmain.htm, the program continues to playback, say, chapter 2. When it reaches chapter 3, the program switches over to video playback mode.

<HTML>
<HEAD>
<TITLE></TITLE>
<SCRIPT LANGUAGE=“JavaScript”
FOR=“dvdObj” EVENT=“DVDChapterChange”>
<!——

if (2 == dvdObj.Chapter) {

dvdObj.AllowModeSwitch( );
dvdObj.SwitchMode (1);
window.navigate(“WMain.htm”)
// Display HTML Menu in wmain.htm

}

−−>
</SCRIPT>
<SCRIPT LANGUAGE=“JavaScript”>
<!−−
function PlayIt( ){

dvdObj.nTitle = 0
dvdObj.nChapter = 0
Ret = dvdObj.Chapter_Play (1, 1)
dvdObj.ForceMode(2)

}
//−−>
</SCRIPT>
</HEAD>
<BODY onload=“PlayIt( );”>

<OBJECT id=“dvdObj”

classid=“clsid:45CE85CB-8712-11D3-BD2C-
00105ACC3DFC”
width=“640” height=“480”>

</OBJECT>

</BODY>
</HTML>

File: Wmain.htm (in-part)

<HTML>
<HEAD>
<SCRIPT LANGUAGE=“JavaScript”
FOR=“dvdObj” EVENT=“DVDChapterChange”>
<!−−

if (3 == dvdObj.Chapter) {

dvdObj.AllowModeSwitch( );
dvdObj.SwitchMode (2);

}

−−>
</SCRIPT>
<SCRIPT LANGUAGE=“JavaScript”>
<!−−
function Play( ){

dvdObj.nTitle = 0
dvdObj.nChapter = 0
Ret = dvdObj.Chapter_Play (1, 2)

}
//−−>
</SCRIPT>
</HEAD>
<BODY onload=“Play ( );”>
<OBJECT id=“dvdObj”

classid=“clsid:45CE85CB-8712-11D3-BD2C-00105ACC3DFC”
width=“640” height=“480”>

</OBJECT>

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

It is claimed:

1. A method of controlling an operations mode of an optical disc player between a user agent mode and a video playback mode, comprising:
reading an interactive program stored on a local optical disc, wherein said interactive program includes a first function that specifies either of said user agent mode or said video playback mode; and
changing said operations mode of said optical disc player to said specified mode.

2. The method of claim 1, wherein said first function further disables a user control interface to prevent a user from changing said operations mode of said optical disc player.

3. The method of claim 1, wherein said first function does not disable a user control interface, allowing a user to change said operations mode of said optical disc player.

4. The method of claim 1, wherein said interactive program further includes a second function that enables a user control interface to allow a user to change said operations mode of said optical disc player.

5. The method of claim 1, wherein said local optical disc comprises a digital versatile disc.

6. The method of claim 1, wherein said optical disc player comprises a dedicated optical disc player.

7. The method of claim 1, wherein said optical disc player is embodied in a computer system.

8. An optical disc for controlling an operations mode of an optical disc player between a user agent program and a video playback mode, comprising:
an interactive program including a first function that causes said optical disc player to change said operations mode from said user agent mode to said video playback mode or vice-versa.

9. The optical disc of claim 8, wherein said first function further disables a user control interface of said optical disc player to prevent a user from changing said operations mode of said optical disc player.

10. The optical disc of claim 8, wherein said first function does not disable a user control interface of said optical disc player, allowing a user to change said operations mode of said optical disc player.

11. The optical disc of claim 8, wherein said interactive program further includes a second function that enables a user control interface of said optical disc player to allow a user to change said operations mode of said optical disc player.

12. The optical disc of claim 8, wherein said optical disc comprises a digital versatile disc.

13. The optical disc of claim 8, wherein said optical disc player comprises a dedicated optical disc player.

14. The optical disc of claim 8, wherein said optical disc player is embodied in a computer system.

15. A computer readable medium storing a program interpreter that recognizes and causes an execution of a first function stored in a local optical disc of an optical disc player, wherein said first function causes an operations mode of said optical disc player to change from a user agent mode to a video playback mode or vice-versa.

16. The computer readable medium of claim 15, wherein said first function further disables a user control interface to prevent a user from changing said operations mode of said optical disc player.

17. The computer readable medium of claim 16, wherein said first function does not disable a user control interface, allowing a user to change said operations mode of said optical disc player.

18. The computer readable medium of claim 16, wherein said program interpreter further recognizes and causes an execution of a second function that enables a user control interface to allow a user to change said operations mode of said optical disc player.

19. The computer readable medium of claim 16, wherein said local optical disc comprises a digital versatile disc.

20. The computer readable medium of claim 16, wherein said optical disc player comprises a dedicated optical disc player.

21. The computer readable medium of claim 16, wherein said optical disc player is embodied in a computer system.

22. An optical disc player, comprising:
an optical disc reading device to read an interactive program stored on a local optical disc;
a video/audio interface to interface with a displaying device for displaying a user agent menu and/or a video playback menu; and
a processor to execute a first function of said interactive program which changes an operations mode of the optical disc player from a user agent mode where the user agent menu is activated for interaction by a user or a video playback mode where the video playback menu is activated for interaction by said user.

23. The optical disc player of claim 22, further comprising a user control interface to allow said user to change said operations mode of said optical disc player.

24. The optical disc player of claim 23, wherein execution of said first function disable said user control interface to prevent said user from changing said operations mode of said optical disc player.

25. The optical disc player of claim 23, wherein said processor is capable of executing a second function of said interactive program that enables said user control interface to allow said user to change said operations mode of said optical disc player.

26. The optical disc player of claim 22, wherein said optical disc reading device is capable of reading a digital versatile disc.

27. The optical disc player of claim 22, wherein said optical disc player comprises a dedicated optical disc player.

28. The optical disc player of claim 22, wherein said optical disc player is embodied in a computer system.
